(19) United States
(12) Patent Application Publication
(10) Pub. No.: US 2014/0201087 A1
(43) Pub. Date: Jul. 17, 2014

(54) TOUCH SCREEN HAVING INTEGRATED EPP, AND INPUT INFORMATION PROCESSING METHOD FOR AUTOMATED TELLER MACHINE USING SAME

(71) Applicants: Jae Whan Shin, Anyang-si (KR); Su Youl Baik, Suwon-si (KR)

(72) Inventors: Jae Whan Shin, Anyang-si (KR); Su Youl Baik, Suwon-si (KR)

(73) Assignee: NAUTILUS HYOSUNG INC., Seoul (KR)

(21) Appl. No.: 14/237,863

(22) PCT Filed: Aug. 9, 2012
(86) PCT No.: PCT/KR2012/006349

§ 371 Date: Mar. 6, 2014

(30) Foreign Application Priority Data
Aug. 10, 2011 (KR) 10-2011-0079526
Dec. 28, 2011 (KR) 10-2011-0144098

(51) Int. Cl. G06F 21/83; G06Q 20/38; G06Q 20/40

(52) U.S. Cl. CPC G06F 21/83; G06Q 20/4012; G06Q 20/382
USPC 705/72; 705/73

(57) ABSTRACT

The present invention relates to a touch screen having an integrated EPP and an input information processing method for an automated teller machine using the same, and more particularly, to a touch screen provided as user interface in an automated teller machine, wherein the touch screen and an EPP module are formed integrally such that a screen displayed on the touch screen is configured to be controlled by a security CPU of the EPP module integrated with the touch screen when a customer using the automated teller machine inputs information required to be encrypted, such as a password required for a financial transaction, through the touch screen of the automated teller machine during the financial transaction, thereby initially preventing the leakage of important financial information through the illegal hacking of the CPU of the automated teller machine and the like.

### TECHNICAL FIELD

The present invention relates to an EPP-integrated touch screen and an input information processing method of an automated teller machine using the same. More particularly, the present invention relates to an EPP-integrated touch screen and an input information processing method of an automated teller machine using the same, in which in configuring the touch screen provided as a user interface in the automated teller machine, the touch screen and an EPP module are integrally configured so that when a customer using the automated teller machine inputs information required to be encrypted such as a password needed for a financial transaction through the touch screen of the automated teller machine while performing the financial transaction, a screen displayed on the touch screen may be controlled through a security CPU of the EPP module integrated in the touch screen, and thus leakage of important financial information through illegal hacking or the like of the CPU of the automated teller machine may be fundamentally prevented.

### BACKGROUND ART

An automated teller machine (ATM) is equipment which allows a bank customer to process various financial transactions and businesses instead of a teller at a counter of the bank. Each financial institute enhances efficiency of performing a business and obtains an effect of saving personnel expenses by distributing the business such that a business directly serviced for a customer by a staff member of the institute is processed at a counter and a comparatively simple business is promptly processed at an automated teller machine.

In order to process a financial transaction or business using such an automated teller machine as described above, a process of inserting a card or a passbook or inputting personal information into the automated teller machine using a keypad by a customer is essentially required so that the automated teller machine may recognize the personal information of the customer, and since specific personal information such as a password input into the automated teller machine through the keypad among the input personal information is extremely important from the viewpoint of security, it should be protected by encrypting the information without fail. Therefore, an encrypting pin pad (EPP) provided in a conventional automated teller machine is attached to a numeral input pad installed around a UI screen and performs a function of processing information which absolutely requires security among the information input through the pad after encrypting the information.

Meanwhile, since a touch screen is provided in an automated teller machine recently, it is generalized that a customer using the automated teller machine processes a financial transaction or business in a method of inputting information through the touch screen as directed by a displayed screen. However, although such a touch screen is advantageous, most of automated teller machines still request a customer to use an EPP integrated keypad provided to be separated from the touch screen when the customer inputs information required to be encrypted such as a password due to a security reason. In this case, although security of the input password or the like may be maintained by the EPP integrated in the keypad in a method of encrypting the information input through the keypad, it is inconvenient in that the customer of the automated teller machine should use the automated teller machine moving his or her eyes to the keypad provided to be separated from the touch screen while processing the financial business looking at the touch screen.

In order to solve the inconvenience, an automated teller machine provided with an EPP-integrated touch screen is used recently, and a customer using such an automated teller machine inputs information needed for a financial transaction through the touch screen, and the input information is encrypted by the EPP integrated in the touch screen. However, even in this case, there is a problem in that security may be weakened since a main CPU of the automated teller machine entirely controls various kinds of screens displayed on the touch screen and related to processing the financial transaction.

That is, when the main CPU of the automated teller machine controls display of all the screens including a screen displayed on the touch screen (hereinafter, referred to as a “security screen”) in a financial transaction step requesting input of information necessarily required to be encrypted such as a password, since the main CPU is wiredly or wirelessly connected to the outside of the automated teller machine and maintains an on-line state at all times, security of the automated teller machine is very vulnerable, and thus it is highly probable that the main CPU is illegally hacked and various kinds of screens related to the financial transaction process are maliciously used for leaking important information of a customer such as a password.

For example, if the main CPU of the automated teller machine is illegally hacked and a criminal controls display of the security screen, the criminal may display a password input screen on the touch screen and steal a password in a financial transaction step which does not encrypt information input through the touch screen. That is, in a specific financial transaction step in which the EPP does not operate, if the criminal illegally hacking the main CPU manipulates to display the password input screen instead of a screen corresponding to the above step, a password doubtlessly input by a customer according to the displayed password input screen can be handed over to the criminal without being encrypted.

### DISCLOSURE

### [Technical Problem]

The present invention is conceived to solve the problems described above in the prior art. That is, an object of the present invention is to provide an EPP-integrated touch screen and an input information processing method of an automated teller machine using the same, in which in performing a financial transaction through the automated teller machine provided with the EPP-integrated touch screen, when a security screen for inputting information required to be encrypted among various kinds of screens needed for processing the financial transaction is displayed on the touch screen, a security CPU of an EPP module integrated in the touch screen controls the displayed security screen, and thus leakage of a password may be prevented although the main CPU of the automated teller machine is illegally hacked.

### [Technical Solution]

According to an aspect of the present invention for achieving the objects, there is provided an EPP-integrated touch screen provided in an automated teller machine includes a touch panel for displaying a screen for processing a financial transaction and inputting customer information; a security CPU for controlling display of a security screen for inputting information required to be encrypted and encrypting the customer information input through the touch panel; a dedicated graphic chip for storing data of the security screen and transmitting the security screen data under the control of the security CPU; and a scaler for receiving the security screen data and displaying the security screen to be appropriate to a specification of the touch panel, wherein the security CPU controls the display of the security screen in a financial transaction step of displaying the security screen on the touch screen.

In addition, according to another aspect of the present invention for achieving the objects, there is provided an input information processing method of controlling display of various kinds of financial transaction screens needed for a financial transaction and processing information input by a user according to the control, in an automated teller machine provided with an EPP-integrated touch screen in which a touch panel and an EPP module for encrypting information input through the touch panel are integrally configured, wherein display of a security screen is controlled through a security CPU of the EPP module integrated in the touch panel when the security screen for inputting information required to be encrypted among the financial transaction screens is displayed on the touch panel, and display of a general financial transaction screen is controlled through a main CPU of the automated teller machine when the general financial transaction screen other than the security screen among the financial transaction screens is displayed on the touch panel.

### [Advantageous Effects]

An EPP-integrated touch screen in accordance with the present invention and an input information processing method of an automated teller machine using the same are configured to control a security screen through a security CPU of an EPP module integrated in the touch screen, so that the display of the security screen for inputting various kinds of information required to be encrypted such as a password and a process of the input information are performed through the security CPU of the EPP module isolated from an external network and integrated in the touch screen, whereby leakage of important financial information such as a password input through the EPP-integrated touch screen and required to be encrypted, which occurs by illegally hacking a main CPU of the automated teller machine through the external network, may be fundamentally prevented.

Also, in the present invention, when a general transaction screen is displayed on the touch screen, since the main CPU of the automated teller machine provides the security CPU with information on an area for inputting touch coordinates in a screen displayed on the touch panel, when a customer uses a hacked automated teller machine, if not a menu needed in a corresponding transaction step but a separate information input screen generated by hacking is displayed in a transaction screen on the touch panel and the customer inputs unique information such as a password by touching the displayed information input screen, input coordinate values input on the touch panel belong to a range other than a previously set input coordinate area, i.e., an area where input keys needed for the corresponding transaction step are displayed, so that the security CPU of the EPP module compares information on a previously notified input area with actually touched input coordinates on the touch panel, and if the input coordinate values are out of a range of the previously set input area, the security CPU blocks transmission of the corresponding coordinates to the main CPU, whereby leakage of customer information by illegal hacking may be fundamentally prevented.

### DESCRIPTION OF DRAWINGS

FIG. 1 is a block diagram schematically showing the configuration of an EPP-integrated touch screen in accordance with one embodiment of the present invention.

FIG. 2 is a view showing operation of an automated teller machine provided with an EPP-integrated touch screen and a control process thereof in accordance with one embodiment of the present invention.

FIGS. 3 to 5 are views showing examples of areas for inputting touch coordinates in general transaction screens displayed on a touch panel in the present invention.

FIG. 6 is a view showing a flow of controlling a displayed screen and processing information input thereby in an automated teller machine provided with an EPP-integrated touch screen in accordance with one embodiment of the present invention.

FIG. 7 is a view showing an information processing flow of an automated teller machine provided with an EPP-integrated touch screen in accordance with one embodiment of the present invention in further detail when a general transaction screen is controlled in the information processing flow.

### BEST MODE

Hereinafter, although embodiments of the present invention will be described in detail, the present invention is not limited to the embodiments described below unless the spirits of the present invention is deviated.

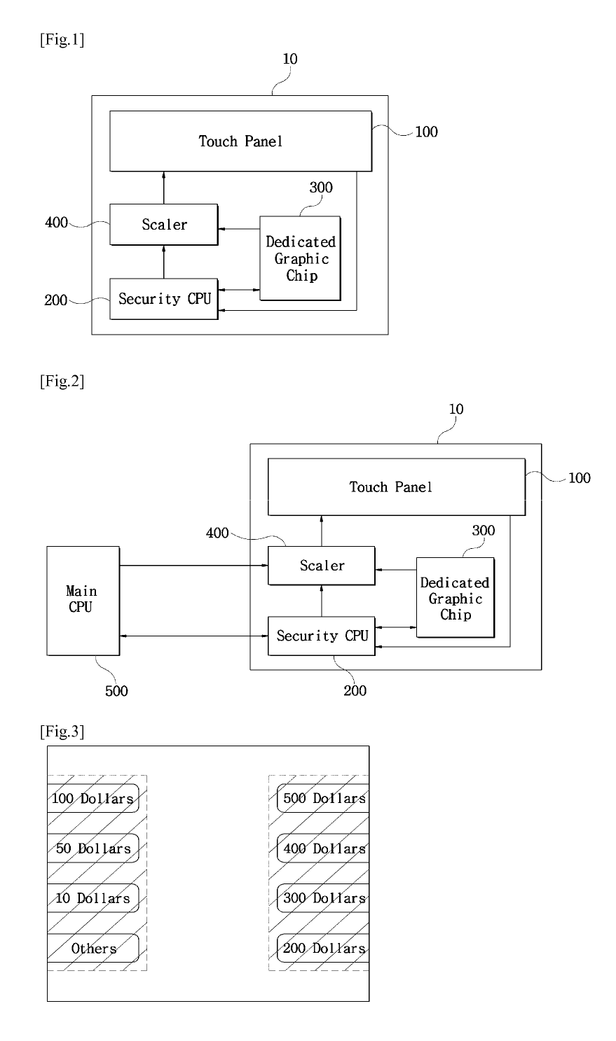

FIG. 1 is a block diagram schematically showing the configuration of an EPP-integrated touch screen in accordance with one embodiment of the present invention.

As shown in FIG. 1, an EPP-integrated touch screen 10 in accordance with one embodiment of the present invention integrally includes a touch panel 100 for displaying various kinds of screens needed for processing a financial transaction and inputting various kinds of information needed for processing the financial transaction by a user; a security CPU 200 for controlling display of a security screen for inputting information necessarily required to be encrypted such as a password input screen among the screens displayed on the touch panel 100 and encrypting information input according to the displayed security screen; a dedicated graphic chip 300 for storing data of the security screen displayed on the touch panel 100 and transmitting the stored data of the security screen to a scaler 400 under the control of the security CPU 200; and the scaler 400 for receiving the data of the security screen to be displayed on the touch panel 100 and converting the received security screen data to be appropriate to the specification of the touch panel 100 to thereby provide the converted data to the touch panel 100.

At this point, the password input screen is necessarily included in the security screen controlled by the security CPU 200, and, in some cases, it may be set to include a variety of information input screens such as an amount input screen and an account number input screen in the security screen. In addition, a version of the security screen data stored in the dedicated graphic chip 300 may be checked in real-time when the automated teller machine is booted, and the security screen data may be updated through a server of a financial institute.

Referring to FIG. 1, when the security screen needs to be displayed on the EPP-integrated touch screen 10, the security CPU 200 directs the dedicated graphic chip 300 to transmit the security screen data to the scaler 400, and if the scaler 400 converts the security screen data transmitted from the dedicated graphic chip 300 to be appropriate to the specification of the touch panel 100, a security screen converted as such is displayed through the touch panel 100. Then, if a customer inputs information required to be encrypted according to the displayed security screen, the touch panel 100 is configured to transmit the input information to the security CPU 200, and the security CPU 200 is configured to encrypt the received information.

Meanwhile, the EPP-integrated touch screen 10 in accordance with the present invention as described above is additionally provided with a field programmable gate array (FPGA) chip supporting a function of the security CPU 200 in order to perform a support function such as temporarily storing updated security screen data, matching input information transmitted from the touch screen to the security screen data and transferring the input information to the security CPU.

FIG. 2 is a view showing operation of an automated teller machine provided with an EPP-integrated touch screen and a control process thereof in accordance with one embodiment of the present invention.

A financial transaction processing screen displayed on the EPP-integrated touch screen 10 may be divided into a security screen for inputting information required to be encrypted and a general transaction screen requested for processing a financial transaction in the automated teller machine other than the security screen. At this point, in the automated teller machine having the EPP-integrated touch screen 10 in accordance with the present invention, in a financial transaction step in which the general transaction screen is displayed on the touch panel 100, data of the general transaction screen is transmitted to the scaler 400 under the control of a main CPU 500, and in a financial transaction step in which the security screen is displayed, the main CPU 500 hands over the authority of controlling the screen to the security CPU 200 of the EPP module provided in the EPP-integrated touch screen 10 to transmit the security screen data stored in the dedicated graphic chip 300 of the EPP module to the scaler 400 under the control of the security CPU 200.

That is, as shown in FIG. 2, when the general transaction screen is displayed, the scaler 400 receives image data of the general transaction screen through a data transmission line connected to the main CPU 500 and displays the general transaction screen through the touch panel 100, and in a step of requesting display of the security screen, the scaler 400 blocks the transmission of the image data of the general transaction screen input from the main CPU 500 under the control of the security CPU 200, opens a data transmission line connected to the dedicated graphic chip 300, and receives data of the security screen transmitted from the dedicated graphic chip 300.

Then, the security information input by the customer according to the security screen displayed on the touch panel 100 is transmitted to the security CPU 200 and encrypted by the security CPU 200 and then transmitted to and processed by the main CPU 500, and thus, the security information required to be encrypted such as a password may be used in a financial transaction step while maintaining an encrypted state at all times.

Meanwhile, in a financial transaction step in which the image data of the general transaction screen is transmitted from the main CPU 500 to the scaler 400 and the general transaction screen is displayed on the touch panel 100 through the scaler 400, the main CPU 500 provides the security CPU 200 with information on an area for inputting touch coordinates in a screen displayed on the touch panel 100 based on the image data of the general transaction screen.

At this point, if a customer inputs touch coordinates in a range out of the area for inputting touch coordinates on the touch panel 100, the security CPU 200 performs a function of blocking transmission of information to the main CPU 500 based on the information on the area for inputting touch coordinates on the touch panel 100 received from the main CPU 500.

That is, when the main CPU 500 of the automated teller machine transmits the image data of the general transaction screen needed for processing a financial transaction to the touch panel 100, as the information on the area for inputting touch coordinates in a screen displayed on the touch panel 100 is provided to the security CPU 200 at the same time as transmitting the image data, when the customer inputs information through the touch panel 100 of the automated teller machine for a financial transaction, if a touch position of the customer received from the touch panel 100 has coordinates in a range out of a previously set input coordinate area in a corresponding screen of the touch panel 100, the security CPU 200 blocks transmission of the corresponding coordinates to the main CPU 500, and thus, it is possible to prevent a hacking crime of outputting an information input screen generated by hacking in a screen of the input panel 100 and stealing information on the customer through an illegal hacking.

In other words, in order to prevent a hacking crime of stealing information input by a customer through an information input screen, which is displayed by hacking, by displaying the information input screen requesting input of unique information such as a password in a screen of the touch panel 100 in a general financial transaction step in which the EPP does not operate after a criminal attempts the hacking through a cable which transmits data from the main CPU 500 of the automated teller machine to the touch panel 100, information on an area for inputting touch coordinates in a screen displayed on the touch panel 100, i.e., information on an area where an input key needed for a corresponding transaction step is positioned in a screen of the touch panel 100, is provided to the security CPU 200 through the main CPU 500. Therefore, when a customer uses the hacked automated teller machine, although a separate information input screen generated by hacking, which is not a menu needed for the corresponding transaction step, is displayed in a transaction screen on the touch panel 100 and a customer inputs unique information such as a password by touching the displayed information input screen, touch coordinates are input in a range other than an area set to input the touch coordinates on the touch panel 100, i.e., a range other than an area displaying the input key needed for the corresponding transaction step, whereby the security CPU 200 blocks transmission of corresponding coordinate values to the main CPU 500.

FIGS. 3 to 5 are views showing examples of areas for inputting touch coordinates in general transaction screens displayed on a touch panel in the present invention.

Referring to FIG. 3, a screen displaying a withdrawal amount selection menu among general transaction screens of the automated teller machine is shown, and in this case, the main CPU 500 transmits image data related to the withdrawal amount selection menu to the touch panel 100 and, at the same time, transmits information on an area for inputting touch coordinates in the screen where the withdrawal amount selection menu is displayed to the security CPU 200.

As shown in FIG. 3, in the screen where the withdrawal amount selection menu among the general transaction screens is displayed on the touch panel 100, the areas at both side edges of the screen (hatched areas) where the withdrawal amount selection menu is displayed are areas for inputting touch coordinates, and the other areas, i.e., the upper, lower and middle portions of the screen, are areas in a range out of the areas for inputting touch coordinates. If touch coordinates are input in the upper, lower or middle portion of the screen by a customer, the security CPU 200 analyzes corresponding touch coordinate data and blocks transmission of the touch coordinate data to the main CPU 500.

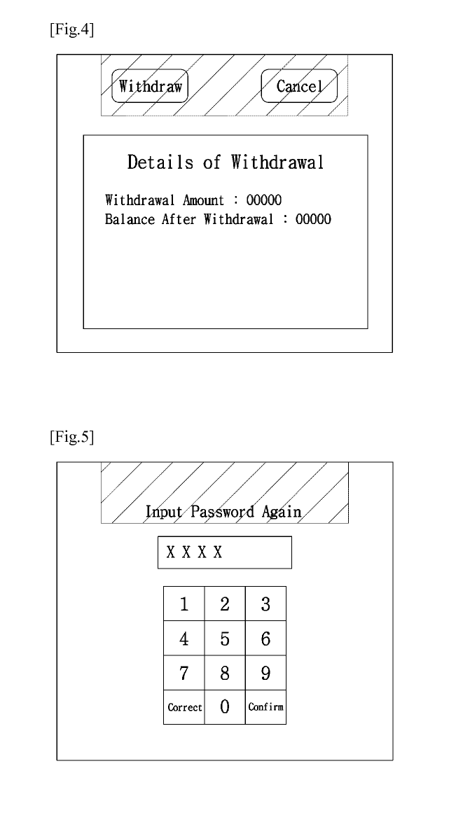

In addition, referring to FIG. 4, a screen displaying a withdrawal confirmation selection menu among the general transaction screens of the automated teller machine is shown, and even in this case, the main CPU 500 transmits image data related to the withdrawal confirmation selection menu to the touch panel 100 and, at the same time, transmits information on an area for inputting touch coordinates in the screen where the withdrawal confirmation selection menu is displayed to the security CPU 200.

As shown in FIG. 4, in the screen where the withdrawal confirmation selection menu among the general transaction screens is displayed on the touch panel 100, an area at the upper portion of the screen (hatched area) where the withdrawal confirmation selection menu is displayed is an area for inputting touch coordinates, and the other areas are areas in a range out of the area for inputting touch coordinates. If touch coordinates are input by a customer in an area out of the area for inputting touch coordinates, the security CPU 200 analyzes corresponding touch coordinate data and blocks transmission of the touch coordinate data to the main CPU 500.

That is, when a screen as shown in FIG. 5 is displayed by hacking in the screen where the withdrawal confirmation selection menu is displayed on the touch panel 100 shown in FIG. 4, although a customer inputs unique information such as a password in an information input screen (password input screen) generated by hacking, since touch coordinates input by the customer are input in an area (i.e., a numeral pad area) other than a range of previously set touch coordinate input area, i.e., the upper portion (hatched area) of the screen where the withdrawal confirmation selection menu is displayed, the security CPU 200 compares information on the touch coordinate input area previously notified from the main CPU 500 with the touch coordinates actually touched by the customer and determines that coordinate values are input in a range out of the area for inputting touch coordinates, whereby the main CPU 500 blocks transmission of corresponding touch coordinate data.

In accordance with the configuration described above, since the main CPU 500 provides the security CPU 200 with information on an area for inputting touch coordinates in a screen displayed on the touch panel 100, i.e., information on an area where a selection menu needed in a corresponding transaction step is positioned in a general transaction screen on the touch panel 100, when a customer uses a hacked automated teller machine, although not the selection menu needed in the corresponding transaction step but a separate information input screen generated by hacking is displayed in a screen of the touch panel 100 and the customer inputs unique information such as a password by touching the displayed information input screen, touch coordinates are input in an area other than the area where the selection menu is positioned in the screen of the corresponding transaction step, and the security CPU 200 blocks transmission of corresponding touch coordinate data to the main CPU 500, whereby leakage of information on the customer by illegal hacking may be prevented.

Meanwhile, when a customer inputs touch coordinates in a range out of the area for inputting touch coordinates on the touch panel 100, the security CPU 200 may control to display an error message on the touch panel 100 based on the information on the area for inputting touch coordinates on the touch panel 100 received from the main CPU 500. If the error is repeated more than a predetermined number of times, the security CPU 200 may control to display a transaction cancellation message on the screen of the touch panel 100.

In addition, if the error described above is continuously repeated more than a predetermined number of times, the security CPU 200 notifies the main CPU 500 of repetition of the input error, and the main CPU 500 informs the customer who uses the automated teller machine of the repetition of the input error by generating an alarm sound through an alarm device provided in the automated teller machine and informs a manager of the repetition of the input error through a communication unit of the automated teller machine.

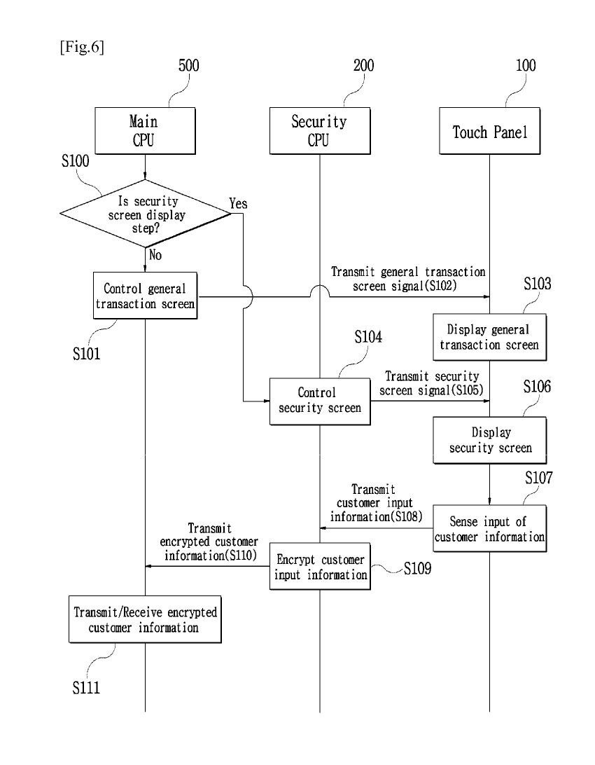

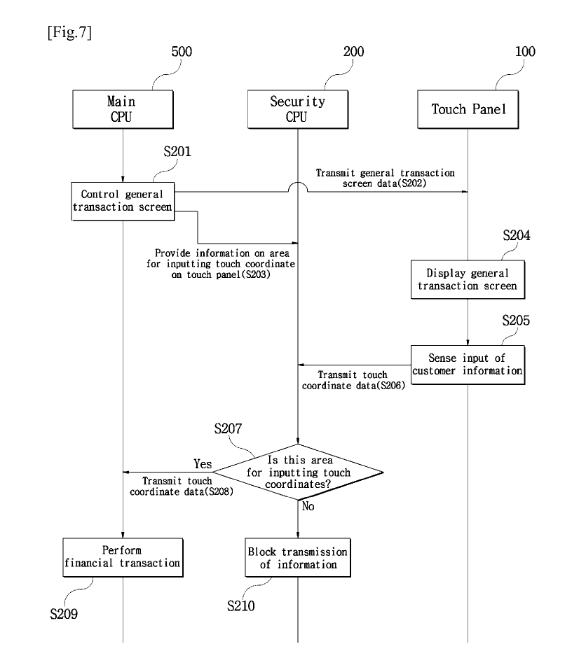

FIG. 6 is a view showing a flow of controlling a displayed screen and processing information input thereby in an automated teller machine provided with an EPP-integrated touch screen in accordance with one embodiment of the present invention.

A flow of controlling a screen displayed on the touch panel 100 will be described with reference to FIG. 6. First, the main CPU 500 determines whether or not it is a step of displaying a security screen on the touch panel 100 in processing a financial transaction (S100), and when not the security screen but a general transaction screen is displayed, the main CPU 500 directly controls the general transaction screen (S101), transmits general transaction screen data to the scaler 400 (S102), and then, displays the general transaction screen on the touch panel 100 (S103).

On the other hand, when the security screen is displayed, the main CPU 500 grants the security CPU 200 of the EPP module an authority for controlling a transaction screen (S104), and the security CPU 200 controls the security screen (S105), accordingly transmits security screen data stored in the dedicated graphic chip 300 to the scaler 400 (S106), and controls to display the security screen on the touch panel 100 (S107).

Then, if a customer inputs information required to be encrypted in the touch panel 100 according to the security screen displayed on the EPP-integrated touch panel 100, the touch panel 100 senses the input (S108) and transmits the input customer information to the security CPU 200 (S109), and the security CPU 200 encrypts the transmitted customer information (S 110) and transmits the encrypted customer information to the main CPU 500 (5111). Then, the main CPU 500 performs the financial transaction using the encrypted customer information transmitted from the security CPU 200 (S 112).

The information required to be encrypted input by the customer as described above may be transmitted to the outside after the encryption is completed through a method of performing all the procedures of recognizing and encrypting the information within the EPP-integrated touch screen. Thus, since the information required to be encrypted such as a password is used in a financial transaction always in an encrypted state, overall security of the financial transaction using an automated teller machine may be improved.

That is, according to the method of the present invention as described above, when a customer using an automated teller machine inputs information required to be encrypted, since a screen can be controlled through the security CPU 200 of the EPP module that is integrated in the touch screen and disconnected from the an external network, an independently secured encryption system is constructed without being controlled by the main CPU 500. In addition, since all the procedures of displaying the security screen, inputting the information required to be encrypted, and encrypting the above information are performed inside the EPP-integrated touch screen, the information required to be encrypted such as a password is transmitted to the main CPU 500 after the encryption is completed and then used in performing a financial transaction using the automated teller machine, thereby providing an advantage to further intensify security of the automated teller machine.

FIG. 7 is a view showing an information processing flow of an automated teller machine provided with an EPP-integrated touch screen in accordance with one embodiment of the present invention in further detail when a general transaction screen is controlled in the information processing flow.

As shown in FIG. 7, when a general transaction screen is displayed, the main CPU 500 controls the general transaction screen (S201), provides the touch panel 100 with general transaction screen data needed for processing a financial transaction (S202), and provides the security CPU 200 with information on an area for inputting touch coordinates in a screen displayed on the touch panel 100 based on the general transaction screen data (S203).

Accordingly, since a transaction screen is displayed on the touch panel 100, a customer may use the automated teller machine (S204), and if information is input on the touch panel 100 by the customer, the touch panel senses the input (S205) and transmits touch coordinate data input by the customer to the security CPU 200 (S206).

Then, the security CPU 200 analyzes whether or not the touch coordinate data input into the screen of the touch panel 100 by the customer is coordinates within a range of a previously set touch coordinate input area based on the information on an area for inputting touch coordinates on the touch panel 100 received from the main CPU 500 (S207) and transmits the corresponding touch coordinate data to the main CPU 500 if the touch coordinate data input by the customer is coordinates belonging to the range of the previously set touch coordinate input area (S208), and the main CPU 500 receives the touch coordinate data transmitted from the security CPU 200 and performs a financial transaction (S209).

On the other hand, if the touch coordinate data input by the customer is coordinates in a range out of the range of the previously set touch coordinate input area, transmission of the corresponding touch coordinate data to the main CPU 500 is blocked (S210).

As described above, as the main CPU 500 of an automated teller machine of the present invention provides the security CPU 200 with information on an area for inputting touch coordinates in a screen displayed on the touch panel 100, when a customer uses a hacked automated teller machine, if not a menu needed in a corresponding transaction step but a separate information input screen generated by hacking is displayed in a transaction screen on the touch panel 100 and the customer inputs unique information such as a password by touching the displayed information input screen, input coordinate values input on the touch panel 100 belong to a range other than a previously set input coordinate area, i.e., an area where input keys needed for the corresponding transaction step are displayed. Thus, the security CPU 200 of the EPP module compares information on a previously notified input area with actually touched input coordinates on the touch panel 100, and if the input coordinate values are out of a range of the previously set input area, the security CPU 200 blocks transmission of the corresponding coordinates to the main CPU 500, and thus, leakage of customer information by illegal hacking may be fundamentally prevented.

As described above, although some specific embodiments have been described herein, it will be apparent that those skilled in the art can make various modifications thereto without departing from the scope of the invention. Therefore, the scope of the present invention is not limited to the embodiment described above but is defined by the appended Claims and equivalents thereof

### INDUSTRIAL APPLICABILITY

Since an EPP-integrated touch screen in accordance with the present invention and an input information processing method of an automated teller machine using the same may thoroughly maintain security on various kinds of screens displayed on the touch panel and related to processing a financial transaction, credibility of a customer may be enhanced when a financial transaction is performed through the automated teller machine.

1. An encryption pin pad (EPP) integrated touch screen provided in an automatic teller machine, integrally comprising:
a touch panel for displaying various kinds of screens needed for processing a financial transaction and inputting various kinds of information needed for processing the financial transaction by a user;
a security CPU for controlling display of a security screen for inputting information required to be encrypted among the screens displayed on the touch panel and encrypting information input according to the displayed security screen;
a dedicated graphic chip for storing data of the security screen displayed on the touch panel and transmitting the stored data of the security screen to a scaler under a control of the security CPU; and
the scaler for receiving the data of the security screen to be displayed on the touch panel, converting the received security screen data to be appropriate to a specification of the touch panel, and providing the converted data to the touch panel.

2. The touch screen according to claim 1, wherein the security screen includes a password input screen.

3. The touch screen according to claim 1, further comprising a field programmable gate array (FPGA) chip for supporting a function of the security CPU.

4. An automatic teller machine having an EPP-integrated touch screen, the EPP-integrated touch screen comprising,
a touch panel for displaying various kinds of screens needed for processing a financial transaction and inputting various kinds of information needed for processing the financial transaction by a user;
a security CPU for controlling display of a security screen for inputting information required to be encrypted among the screens displayed on the touch panel and encrypting information input according to the displayed security screen;
a dedicated graphic chip for storing data of the security screen displayed on the touch panel and transmitting the stored data of the security screen to a scaler under a control of the security CPU; and
the scaler for receiving the data of the security screen to be displayed on the touch panel, converting the received security screen data to be appropriate to a specification of the touch panel, and providing the converted data to the touch panel;
wherein the display of the security screen is controlled through the security CPU integrated in the touch panel when the security screen for inputting information required to be encrypted among the screens displayed on the touch panel is displayed on the touch panel, and display of a general financial transaction screen is controlled through a main CPU of the automated teller machine when the general financial transaction screen other than the security screen is displayed on the touch panel.

5. The automatic teller machine according to claim 4, wherein information input through the touch panel by a customer according to the security screen displayed on the EPP-integrated touch screen is transmitted to the security CPU and encrypted, and then, transmitted to the main CPU of the automated teller machine.

6. The automatic teller machine according to claim 4, wherein when the general financial transaction screen other than the security screen is displayed on the touch panel, the main CPU of the automated teller machine controls the display of the general financial transaction screen and, at a same time, transmits information on an area where input of touch coordinates is expected on the touch panel where the general financial transaction screen is displayed to the security CPU.

7. The automatic teller machine according to claim 6, wherein the security CPU transmits the input touch coordinates to the main CPU only when the touch coordinates are input by a customer within the area where input of the touch coordinates is expected on the touch panel, based on the information on the area where input of the touch coordinates is expected, which is received from the main CPU.

8. The automatic teller machine according to claim 7, further comprising an alarm device for generating an alarm sound when a case in which the touch coordinates input through the touch panel are not included in the area where input of the touch coordinates is expected is continuously repeated more than a predetermined number of times.

9. An input information processing method of controlling display of various kinds of financial transaction screens needed for a financial transaction and processing information input by a user according to the control, in an automated teller machine provided with an EPP-integrated touch screen in which a touch panel and an EPP module for encrypting information input through the touch panel are integrally configured,
wherein display of a security screen is controlled through a security CPU of the EPP module integrated in the touch panel when the security screen for inputting information required to be encrypted among the financial transaction screens is displayed on the touch panel, and display of a general financial transaction screen is controlled through a main CPU of the automated teller machine when the general financial transaction screen other than the security screen among the financial transaction screens is displayed on the touch panel.

10. The method according to claim 9, wherein the security screen includes a password input screen.

11. The method according to claim 9, wherein information input through the touch security screen by a customer is transmitted to the security CPU and encrypted, and then, transmitted to the main CPU of the automated teller machine.

12. The method according to claim 9, wherein when the general financial transaction screen other than the security screen is displayed on the touch panel, the main CPU of the automated teller machine controls the display of the general financial transaction screen and, at a same time, transmits information on an area where input of touch coordinates is expected on the touch panel where the general financial transaction screen is displayed to the security CPU.

13. The method according to claim 12, wherein the security CPU receives information on touch coordinates input from the touch panel, determines whether or not the received touch coordinates are included in the area where input of touch coordinates is expected, the area being transmitted from the main CPU, and transmits the received touch coordinates to the main CPU only when the touch coordinates are included in the area.

14. The method according to claim 13, wherein when the touch coordinates transmitted from the touch panel are not included in the area where input of the touch coordinates is expected, the security CPU controls to display an error message on the touch panel.

15. The method according to claim 14, wherein when a case in which the touch coordinates transmitted from the touch panel are not included in the area where input of the touch coordinates is expected is continuously repeated more than a predetermined number of times, the security CPU notifies the main CPU of repetition of an input error, and the main CPU generates an alarm sound through an alarm device of the automated teller machine and, at a same time, informs a manager of the repetition of the input error through a communication unit of the automated teller machine.

16. The automatic teller machine according to claim 4, wherein the security screen includes a password input screen.

17. The automatic teller machine according to claim 4, further comprising a field programmable gate array (FPGA) chip for supporting a function of the security CPU.
